(19) United States
(12) Patent Application Publication
(10) Pub. No.: US 2014/0259439 A1
(43) Pub. Date: Sep. 18, 2014

(54) Polycarboxylic Acid Polymers For Treatment of Leather

(71) Applicant: Itaconix Corporation, Stratham, NH (US)

(72) Inventors: Lucas PADDOCK, Northwood, NH (US); David G. OUELLETTE, Epping, NH (US); John SHAW, Hampton Falls, NH (US); Yvon DURANT, Lee, NH (US)

(21) Appl. No.: 14/181,117

(22) Filed: Feb. 14, 2014

Related U.S. Application Data
(60) Provisional application No. 61/793,046, filed on Mar. 15, 2013.

(51) Int. Cl. C14C 3/22

(52) U.S. Cl. CPC C14C 3/22
USPC 8/94.33

(57) ABSTRACT

The present invention relates to methods and polymers based upon vinyl type monomers that contain pendant carboxylic acid groups that may be employed for retanning of leather sourced from animal skins or synthetic leather.

### CROSS REFERENCE TO RELATED APPLICATION

This application claims the benefit of U.S. Provisional Application Ser. No. 61/793,046 filed Mar. 15, 2013, the teachings of which are incorporated herein by reference.

### FIELD OF THE INVENTION

The present invention relates to a process for treatment of leather sourced from animal skins or synthetic leather with polymerized vinyl type monomers containing acidic functionality. The polymerized vinyl type monomers are prepared under selected conditions such that the parameters of, e.g., monomer conversion, acid functionality, molecular weight and tacticity may be adjusted to selected levels which polymers may then be applied for animal skin treatment procedures.

### BACKGROUND

The process of transforming animal skin into a useful product is known as tanning. Generally, the first step is a preparation step by curing with salt. Curing is employed to, among other things, prevent decomposition of the protein substance (collagen) during the time period between procuring the skin and further processing. Curing also removes excess water from the hides. This is then following by soaking (to remove residual salt) and liming (treatment with base) to remove hair along with some fibrous soluble proteins, swell and spilt fibers, remove natural grease and fats, and prepare the collagen for tanning.

There are three types of tanning operations: vegetable, mineral and aldehyde. Of the mineral tanning agents, aqueous solutions of basic salts of chromium have been generally accepted and consistently preferred over other mineral tanning agents, such as the basic salts of zirconium and aluminum, because these “chrome-tanning” agents consistently yield superior products. Mineral tanning typically utilizes chromium in the form of chromium (III) sulfate ([CrH₂O)₆]₂(SO₄)₃). Chromium-tanned skin may contain between 4-5% by weight chromium and such tanning will permanently alter the skin's protein structure towards the goal of providing useful commercial products.

Retanning has also been employed in the mineral tanning process to improve the chrome tanned skins and stabilize the tanning agent. “Retanning” may therefore be understood to be the after-treatment of pretanned (generally chrome-tanned) leather in order to optimize color, firmness, strength, levelness, softness, fullness, and behavior to water (hydrophobicity) and to fix tanning agents.

The polymerization of vinyl type monomers that contain pendant carboxylic acid functionality has always presented some unique challenges. For example, U.S. Pat. No. 5,223,592 reports that the critical aspect is to provide complete neutralization of an itaconic acid type monomer prior to conducting the polymerization reaction, where complete neutralization is identified as having two moles of base neutralizer for each mole of itaconic acid. U.S. Pat. No. 5,336,744 reports that polymers of itaconic acid are formed at high conversion by an aqueous polymerization process of partially neutralized monomer solution, water, polyvalent metal ion, and initiator.

U.S. Pat. No. 7,910,676 relates to methods and polymers based upon vinyl type monomers that contain pendant carboxylic acid groups and ester group functionality. U.S. Pat. No. 7,910,677 stands directed at detergents formed from such polymers, and U.S. Pat. No. 7,915,365 stands directed at absorbent materials also formed from such polymers. U.S. Pat. No. 8,227,560 stands directed at polymers that again have pendant carboxylic acid groups and/or ester functionality and wherein the polymer indicates ¹³C NMR triads having a syndiotacity of greater than 58%.

### SUMMARY

The present disclosure is directed at a process for retanning of leather. The leather may be sourced from animal skins or synthetic leather. The process comprises treatment with a polymer material comprising the following repeating unit:

[chemical structure]

wherein R₁ and R₂ are selected from a hydrogen atom or an alkyl group or an aromatic group, or a cyclic alkyl group or a polyether, and combinations thereof and R₃ may be selected from an alkyl group, aromatic functionality, heteroaromatic functionality, cyclic alkyl group, heterocylic group, or combinations thereof, wherein at least 50 mole % of R₁ and R₂ are a hydrogen atom to provide carboxylic acid functionality. The polymer material may be characterized as having at least one of: (1) ¹³C NMR triads having a syndiotacticity of greater than 58.0%; or (2) the value of n for the indicated repeating unit provides a weight average molecular weight of at or above 20,000. The polymer material may optionally be partially or completely neutralized with an inorganic base, organic base, and/or non-metallic hydroxides.

### BRIEF DESCRIPTION OF THE DRAWINGS

The above-mentioned and other features of this disclosure, and the manner of attaining them, will become more apparent and better understood by reference to the following description of embodiments described herein taken in conjunction with the accompanying drawings, wherein:

FIG. 1 shows the 400 MHz ¹H NMR spectra of poly(itaconic acid) in D₂O corresponding to Synthesis A;

FIG. 2 shows the 400 MHz ¹H NMR spectra of itaconic acid monomer in D₂O;

FIG. 3 shows the 400 MHz ¹³C NMR spectra of poly(itaconic acid) in D₂O corresponding to Synthesis A; and

FIG. 4 shows the 400 MHz ¹³C NMR spectra of itaconic acid.

FIG. 5 shows the 400 MHz ¹H NMR spectra of poly(itaconic acid) in D₂O corresponding to Example I.

FIG. 6a shows the 400 MHz ¹³C NMR spectra of poly(itaconic acid) at the chemical shift/ppm of 187 to 175 corresponding to Example I.

FIG. 6b shows the 400 MHz ¹³C NMR spectra of poly(itaconic acid) at the chemical shift/ppm of 56 to 38 corresponding to Example I.

FIG. 7 shows the ¹H NMR spectra of poly(itaconic acid, sodium salt) in D₂O from Example XVIII.

FIG. 8 shows the ¹³C NMR spectra of poly(itaconic acid) in D₂O at pH=1 from Example XVIII.

### DETAILED DESCRIPTION

Throughout the description, like reference numerals and letters indicate corresponding structure throughout the several views. Also, any particular feature(s) of a particular exemplary embodiment may be equally applied to any other exemplary embodiment(s) of this specification as suitable. In other words, features between the various exemplary embodiments described herein are interchangeable as suitable, and not exclusive.

It may be appreciated that the present disclosure is not limited in its application to the details of construction and the arrangement of components set forth in the following description or illustrated in the drawings. The embodiments herein may be capable of other embodiments and of being practiced or of being carried out in various ways. Also, it may be appreciated that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The monomers suitable for polymerization herein include vinyl type monomers that have the following general structure:

[chemical structure]

wherein R₁ and R₂ are selected from a hydrogen atom or an alkyl group (e.g. —(CₙH₂ₙ₊₁) where n has a value of 1-18), or an aromatic group, or a cyclic alkyl group or a polyether, and combinations thereof. In addition, R₃ may be selected from an alkyl group, aromatic functionality, heteroaromatic functionality, cyclic alkyl group, heterocylic group, or combinations thereof, wherein at least 50 mole % of R₁ and R₂ are a hydrogen atom to provide carboxylic acid functionality. In addition, in a particularly preferred embodiment, R1 and R2 are both hydrogen atoms, which therefore provides the monomer generally known as itaconic acid.

An alkyl group may be understood to include combinations of carbon and hydrogen, including unsaturated carbon-carbon linkages, which are not prone to polymerization, such as radical polymerization. Furthermore, the number of carbon atoms in the alkyl group as alluded to above may be in the range of 1-18, including all values therein in 1 carbon increments. In addition, reference to heteroaromatic functionality may be understood as reference to an aromatic ring containing a heteroatom (e.g., nitrogen, oxygen, sulfur or phosphorous) and reference to a heterocyclic group may be understood as reference to a non-aromatic carbon ring structure also containing one or more heteroatoms.

In addition, it should be noted that the vinyl type monomers with the above indicated structure, when in acidic form, may be optionally partially or completely neutralized with any base such as monovalent inorganic bases, e.g., M⁺[OH—]ₓ where M represents a cationic moiety selected from sodium, potassium, and/or lithium and x assumes a value to provide a neutralized salt. In addition, it is contemplated herein that one may employ non-metallic hydroxides, such as ammonium hydroxide, as well as organic base compounds, including primary and other amines (e.g., an alkyl amine such as monomethyl amines, dimethyl amines, trimethylamines, monoethylamine, diethylamine, triethylamine).

Comonomers may also be employed in conjunction with the above monomeric compounds, which may then provide random copolymer structure. With respect to the use of any comonomer, it should be appreciated that the vinyl monomers noted above containing the indicated R₁, R₂ and R₃ functionality may be preferentially present at a level of equal to or greater than 50 wt. %.

The comonomers that may then be utilized include any vinyl type monomer that would be suitable for copolymerization, including, but not limited to acrylate monomers (such as methyl methacrylate, methyl acrylate, 2-hydroxyethyl acrylate, polyethyleneoxidediacrylate), vinyl acetate, vinyl halides, styrene, acrylamides, olefin monomers (e.g. ethylene or propylene) and acrylonitrile. In addition, the comonomers may include vinyl type anhydride monomers, such as maleic acid anhydride, itaconic acid anhydride as well as other acidic functionalized monomers, such as citraconic acid or measaconic acid (however, as noted herein, the levels of these latter monomers may require selected control of the concentration in the polymerization medium). Comonomers may also extend to water soluble type monomers, such as vinyl alcohol or vinyl acetate-vinyl alcohol mixtures.

Furthermore, one may utilize multifunctional type vinyl monomers in the event that one desires to achieve some level of crosslinking. For example, one may preferably employs a multifunctional vinyl monomer, which may be understood as a monomer that provides two or more vinyl type groups suitable for chain-type addition polymerization. One example of such a difunctional monomer includes polyethyleneglycoldiacrylate (PEGDA) which may have the following structure: H₂C═CHCO(OCH₂CH₂)ₙO₂CCH═CH₂, wherein n may assume a value of 1-500.

### Neutralization

It has been found that to provide for relatively more efficient polymerization and in particular relatively high conversion (e.g. conversion of at or greater than 75% wt of the monomer) the monomers identified herein may preferably be first neutralized under selected conditions in order to optimize the ensuing polymerization which may then improve values of conversion and/or molecular weight. The molecular weights that are improved may include the number average molecular weight (Mn) and/or weight average molecular weight (Mw).

Neutralization may be accomplished by treatment of the acidic monomers with any base, such as monovalent inorganic bases, e.g., M⁺[OH⁻]ₓ wherein M represents a cationic moiety selected from sodium, potassium, lithium and x assumes the value to provide a neutralized salt. In addition, it is contemplated herein that one may employ non-metallic hydroxides, such as ammonium hydroxide, as well as organic base compounds, including primary amines (e.g. an alkyl amine such as monomethyl amines, dimethylamines, trimethylamines, monoethylamine, diethylamine, triethylamine) and/or organic compounds containing hydroxyl (OH) group functionality (e.g. ethylene glycol).

The amount of neutralization may be adjusted to provide a less than complete neutralization of the acidic groups present on the vinyl monomers noted herein. For example, in the case of the representative monomer of itaconic acid, it may be understood that complete neutralization will require two moles of neutralizer for each mole of itaconic acid. That is, two moles of sodium hydroxide would provide complete neutralization of one mole of itaconic acid, and any amount of sodium hydroxide less than two moles would provide the desired result of partial neutralization.

Those of skill in the art would recognize that when a divalent based is employed to neutralize itaconic acid, the amount of divalent base selected to completely neutralize itaconic acid would be 1.0 mole of divalent base for each mole of itaconic acid, and to partially neutralize, less than one mole of divalent base may be applied to partially neutralize the itaconic acid monomer.

It has been found that the level of neutralization herein may be preferentially maintained at about 25.0 mole % to 85.0 mole %, including all values therein, in 1.0 mole % increments. For example, for a 1.0 moles of itaconic acid, one may preferably neutralize 0.25 moles of the acid groups present to 0.85 moles of the acid groups present. More preferably, the level of neutralization may be maintained at a level of 40.0 mole % to 60.0 mole %, and in a most preferred embodiment, the level of neutralization of the acid monomer selected may be in the range of 45.0 mole % to 55.0 mole %.

The temperature at which partial neutralization may be achieved may also be adjusted such that neutralization is accomplished at temperatures of 50.0° C. to 150° C., including all values therein, in 1.0° C. increments. For example, it is preferable that the neutralization temperature is adjusted to be 50° C. to 110° C., and in a most preferred configuration, the neutralization temperature is adjusted to be in the range of 65° C. to 100° C.

The time for neutralization has also emerged as another variable to regulate and may also be selected herein to occur for a selected and relatively limited period of time prior to any ensuing polymerization. For example, one may partially neutralize according to the requirements noted above and allow for such partial neutralization to remain at the previously specified neutralization temperatures for a period of time up to and including 6.0 hours, including all time periods between 0.1 hours to 6.0 hours, in 0.1 hourly increments. More preferably, the neutralization time period at the previously specified temperature may be selected such that it does not exceed a time period of 2.0 hours. Finally, the neutralization time period at the previously specified temperature may be preferably selected such that it does not exceed a time period of 1.0 hours.

In addition, it may be appreciated that one may accomplish neutralization by, e.g., operating for no more than an accumulated time period of 6.0 hours at a temperature of 50° C. to 150° C., by cooling outside such temperature and time period, to otherwise limit isomerization of the reacting monomers, as discussed more fully below. For example, one may partially neutralize as noted above for a period of 0.5 hours at a temperature of 50° C. to 150° C., then cool to about 25° C. This may then be followed by heating and neutralizing for another 0.5 hours at a temperature of 50° C. to 150° C. This then would provide a preferred time and temperature of neutralization, prior to polymerization, of 1.0 hours at a temperature of 50° C. to 150° C.

With respect to the above disclosure regarding the control of neutralization of the acidic vinyl monomers, and in particular, the representative monomer of itaconic acid, it is noted that the use of partial neutralization, at the indicated neutralization temperatures and/or at the indicated neutralization times, may provide for the ability to minimize the isomerization of the vinyl acid monomer (e.g. itaconic acid) to chain terminating structures (i.e. compounds that impede the conversion itaconic acid to poly(itaconic acid). For example, the level of chain terminator, which may be formed from the acidic vinyl monomers may now be controlled to be present at or below the level of 20.0 mole percent, for each mole of acidic vinyl monomer that is initially present. More preferably, the level of chain terminator sourced from the acidic vinyl monomer may be controlled, through the neutralization procedures noted herein, to be present at levels of at or below 10.0 mole percent for each mole of acidic vinyl monomer, and in the most preferred embodiment, such level of chain terminator is controlled to be present at or below 5.0 mole percent. For example, the level of chain terminator may preferentially be adjusted to be in the range of 0.1 mole percent to 5.0 mole percent.

One representative example of the formation of chain terminator from a vinyl acidic monomer again points to the representative use of itaconic acid. More specifically, it is contemplated that itaconic acid may rearrange to provide citraconic acid or mesaconic acid, according to the following general equation, which citraconic or mesaconic acid, as a tri-substituted vinyl monomer, is believed to retard polymerization conversion and/or molecular weight.

[chemical structure]

### Polymerization

Subsequent to neutralization, according to the use of the partial neutralization noted herein at the indicated windows of, e.g., time and temperature, polymerization may be initiated. Initially, the vinyl monomers noted herein containing acidic functionality may be combined in a solvent to provide a solids content of 50 wt. % to 90 wt. %, including all values therein in 1.0 wt. % increments. The solids content may more preferably be in the range of 60 wt. % to 80 wt. % or 65 wt. % to 75 wt. %. Solids content may be understood as the wt. % of monomer in the solvent that is employed.

One may then employ radical initiation, utilizing free radical initiators such as peroxides and azo compounds, such as azobisisobutyronitrile (AIBN). One may also preferably utilize water-soluble radical initiators wherein the initiators are prepared in solution by dissolving the selected initiator in deionized water or a combination of water miscible polar solvents. Water soluble initiators may include persulfate salts, such as ammonium persulfate, sodium persulfate and potassium persulfate, including mixtures thereof. Also useful as a water soluble initiator are hydrogen peroxide (H₂O₂), tertiobutyl hydroperoxide, and water soluble azo initiators.

The initiators may be present at the concentration of 0.05 wt. % to 15.0 wt. % of monomer present, and all values therein, at 0.05 wt. % increments. More preferably, the initiators may be present at a level of 0.10 wt. % to 6.0 wt. % of monomer present, or at a level of 0.20 wt. % to 4.0 wt. % of the monomer present. In addition, the initiators may be selected such that they have an effective temperature for a 10.0 hour half-life (T10)_{1/2}, or time to decrease to half of their initial concentration, of less than or equal to 100° C.

In other words, preferentially, the initiators are selected such that less than half of the initiator remains present after 10 hours, at temperatures above 100° C. In this manner, it can be assured that sufficient free radicals are generated during the polymerization.

The initiator may be sequentially introduced into the polymerization solution (monomer and solvent) by introducing the herein disclosed amount of initiator over the first 75% of the time assigned for polymerization. For example, for a 3 hour polymerization period, one may introduce the initiator such that the first 50% of all initiator to be added is introduced at the start of the polymerization period, and the remaining 50% is added over the 2.25 hours. Furthermore, one may elect to add all of the desired amount of initiator at the start of the selected polymerization period. However, it may be preferred to utilize sequential addition, as this may support continuous polymerization processes.

The solution of monomer and solvent, subsequent to the neutralization procedures noted herein, may then be heated to a temperature of 50° C. to 150° C., including all values therein in 1.0° C. increments. More preferably, the polymerization temperature may be set to 70° C. to 115° C. or 80° C. to 110° C. In addition, the time for polymerization of the monomers may be from 0.1 hours to 48 hours, including all values therein, in 0.1 hour increments. More preferably, the time for polymerization may be set to a time period of 0.2 hours to 12.0 hours or 0.3 hours to 3.0 hours.

### Polymer MW And Tacticity

The polymers produced herein have been found to have weight average molecular weights (Mw) at or above 20,000 g/mole, and number average molecular weights (Mn) at or above 5,000 g/mole. More specifically, the values of Mw obtained herein may be in the range of 20,000 to 1,000,000 g/mole including all values therein, in increments of 1000. For example, Mw values that may be obtained herein may be in the range of 20,000 to 350,000 g/mole. Similarly, Mn values may be in the range of 5,000 to 25,000 g/mole including all values therein in increments of 1000.

It is also contemplated herein that one may, e.g., combine and react the monomers under the neutralization conditions noted herein (e.g. partially neutralizing the acid functionality at a level of 25.0 mole % to 85.0 mole %) for each mole of carboxylic acid functionality present, wherein said partial neutralization takes place over a time period not to exceed 6.0 hours at a temperature of 50° C. to 150° C.), such that the above MW values are obtained. Then, one may optionally introduce crosslinking, which may be achieved by the introduction of a monomer that provides crosslinking (e.g. a monomer containing 3 or more vinyl groups). In such manner, the polymers produced herein may become part of a crosslinked network while maintaining their indicated functionality characteristics for the substituents R₁, R₂ and R₃, noted herein.

The polymers prepared herein may also have a desired level of tacticity with respect to the analysis of triad structure by NMR techniques. For example, the polymers herein may specifically be formed with the presence of syndiotactic triads, at a level of greater than 58.0%. For example, the level of syndiotactic triads as determined by NMR techniques, such as ¹³C NMR, may be formed at the level of greater than 58.0% to 75.0%, including all values therein, in 1.0% increments.

### EXAMPLES

### C-13 NMR Analysis

13C NMRs were obtained with a Varian (500 MHz ¹H) with 45° pulse angle, 12 s delay between pulses/re magnetization and 3000 accumulations. The experiments were performed at T=25° C. in 5 mm diameter NMR tubes. NMR samples had a concentration of approximately 0.25 g/g in D₂O. A drop of 1,4-dioxane was added to each sample as reference (peak at 67.4 ppm). The pH was adjusted with a solution of hydrochloric acid at 12N. All samples had pH between 0.2 and 1.5. Tacticity was determined from the chemical shifts of the triads from the beta carbonyl with the following assignments:
178.7 ppm rr triad (s-syndiotactic)
178.2 ppm mr triad (h-atactic or heterotactic)
177.6 ppm mm triad (i-isotactic)
   Syndiotacticity is calculated as the ratio of the area of the rr triad over the area of all triads (rr+mr+mm).

“Synthesis A” was conducted using the representative monomer itaconic acid; 2,2′-azodiisobytyronitrile (AIBN), hydrogen peroxide; tertio butyl hydroperoxide (tBHP); ferric ammonium sulfate; toluene; Span 80; and hydrochloric acid, without further purification. 50 g (0.385 mol) of itaconic acid was half neutralized with 5 g (0.385 mol) sodium hydroxide, and was dissolved in 25 ml deionized water into a flask, and 8 mg ferric ammonium sulfate was added. The mixture was heated to 80° C. and 25 ml tBHP (70 wt % in water); 50 ml H202 (35 wt % in water) were fed by syringe pump for 2 hours, and heat was maintained for an additional 4 hours. The product was dried at 25° C. under vacuum for 10 hours.

A Varian 400 MHz NMR was used to investigate the structure of the resulting polymers. FIG. 1 shows the ¹H NMR spectra for Synthesis A, where the two vinylic proton peaks in the itaconic acid monomer, as shown in FIG. 2, disappeared completely, and the IR spectra for Synthesis A supports it, and two distinct peaks with the similar area around 2.7 ppm and 2.0 ppm describe the CH₂ in the side group and backbone separately, indicating the structure of poly(itaconic acid). The sample from Synthesis A analyzed by ¹H NMR was not precipitated in acetone, and the calculated polymerization yield was 100%. However, some additional sharp peaks were observed in the ^{I}H NMR indicating an extensive and complex reaction of the large quantity of the redox initiator.

The five resonance frequencies of the ¹³C NMR spectra of the Synthesis A and itaconic acid monomer, as shown in FIGS. 3 and 4, are compared in Table 1.

TABLE 1

| Carbon | C1 | C2 | C3 | C4 | C5 |
|---|---|---|---|---|---|
| Chemical Shifts For Itaconic | 128.0 | 130.5 | 36.8 | 176.2 | 171.1 |
| Acid (ppm) | | | | | |
| Chemical Shifts For | 47.8 | 49.2 | 42.8 | 178.9 | 180.6 |
| Poly(itaconic acid) (ppm) | | | | | |

After polymerization, the chemical shifts of the carbons in side groups do not change much. However, the carbons C1 and C2 of the double bond in the monomer are absent and its resonance is shifted to 45.8 and 47.2 ppm, which is a sign for the formation of a polymer backbone.

With respect to the various polymerizations noted above, it is contemplated herein that the polymerizations may be suitable for a continuous polymerization process (i.e. a polymerization process that runs continuously and continuously provides polymeric material). More specifically, one may utilize a polymerization reactor that may be described as containing optionally a single or double shaft with helicoidal elements that may then mix and displace the polymerizing reactants (see again, the above indicated monomers) along a main tube. The elements may be designed to maintain the reacting materials from stagnating at any given point within the tubular reactor, while displacing or conveying the materials in order to optimize heat transfer, mass transport and mixing. The residence time of the reactants in the tube may be varied, and the diameter of the tube may be in the range of 0.1 inch to 20 feet, with a length of 2 feet to 1000 feet.

With respect to such a continuous process, the features all noted above with respect to controlling the level of neutralization (25.0 mole % to 85.0 mole %), time for neutralization (not to exceed 6.0 hours at a temperature of 50.0° C. to 150° C.), percent conversion (50% to 99.9%), weight average molecular weight (at or above 20,000 g/mole), syndiotacticity greater than 58% may all again be applied to the continuous polymerization procedure.

### Example I

100 grams of itaconic acid and 50 grams of deionized water were added to a 250 ml plastic beaker and 30.8 grams of sodium hydroxide was added slowly with manually stifling while the beaker was kept cold with an ice water bath. The solution was then added to a 250 milliliter, 3-neck round bottom flask equipped with a mechanical stirrer, nitrogen feed line, water cooled condenser, and thermometer. After the flask content was heated to 100 degree centigrade, 1 ml of 70% tertiobutyl hydroperoxide aqueous solution was added. The reaction was then held for two and a half hours, then cooled down.

The resultant solution showed 97.7 percent conversion of the itaconic acid into a polymer by NMR. FIG. 5 shows the ¹H NMR of this same in D₂O used for the quantification of the polymerization yield. Based on gel permeation chromatography, the average molecular weight was 10,180 g/mole, and the number average molecular weight (Mn) was 3,920 g/mole, in polyacrylic acid equivalent molecular weight. FIGS. 6a and 6b show the ¹³C NMR of this sample with the same peak assignment as used in Table 1, providing evidence for the synthesis of polyitaconic acid.

### Example II

The procedure of EXAMPLE I was repeated except 0.5 milliliter of 70% tertiobutyl hydroperoxide was added after the reaction mixture reached 100 degree centigrade. The reaction was then held for 160 minutes and then cooled down. The resultant solution showed 72.5 percent conversion of the itaconic acid into a polymer by NMR. Based on gel permeation chromatography, the weight average molecular (Mw) was 20,150 g/mole, and the number average molecular weight (Mn) was 7,930 g/mole in polyacrylic acid equivalent molecular weight.

### Example III

The procedure of EXAMPLE I was repeated except 2 milliliter of 70% tertiobutyl hydroperoxide was added after reaching 100 degree centigrade. The reaction was then held for 155 minutes and then cooled down. The resultant solution showed 90.3 percent conversion of the itaconic acid into a polymer by NMR. Based on gel permeation chromatography, the weight average molecular (Mw) was 7,690, and the number average molecular weight (Mn) was 3,390 g/mole in polyacrylic acid equivalent molecular weight.

### Example IV

The procedure of EXAMPLE I was repeated except 30.8 grams of sodium hydroxide was added quickly without cooling and 0.5 milliliter of 70% tertiobutyl hydroperoxide as initiator was added after reaching 100 degree centigrade. The reaction was then held for 80 minutes and then cooled down. The resultant polymer solution showed 67.4 percent conversion of the itaconic acid into a polymer by NMR. Based on gel permeation chromatography, the weight average molecular (Mw) was 11,820 and the number average molecular weight (Mn) was 5,410 g/mole in polyacrylic acid equivalent molecular weight.

### Example V

100 grams of itaconic acid and 50 grams of deionized water were added to a flask and then set to stir and 30.8 grams of sodium hydroxide was added slowly with cooling by ice water. The solution was added to a reaction calorimeter (Chemisens CPA 200) equipped with a mechanical stirrer and thermometer. Nitrogen was purged before reaction 0.5 milliliter of 70% tertiobutyl hydroperoxide as initiator was added after the content was heated to 90 degree centigrade. The reaction was then held for 130 minutes and then cooled and packaged.

### Example VI

The procedure of EXAMPLE I was repeated except 70 grams of deionized water was added and 0.5 milliliter of 70% tertiobutyl hydroperoxide was added after reaching 100 degree centigrade. The reaction was then held for 2 and a half hours and then cooled down.

### Example VII

The procedure of EXAMPLE I was repeated except 100 grams of deionized water was added and 0.5 millliter of 70% tertiobutyl hydroperoxide was added after reaching 100 degree centigrade. The reaction was then held for 85 minutes and then cooled down. The resultant polymer solution showed 30.8 percent conversion of the itaconic acid into a polymer by NMR. Based on gel permeation chromatography, the weight average molecular (Mw) was 15,110 and the number average molecular weight (Mn) was 6,840 g/mole in polyacrylic acid equivalent molecular weight.

### Example VIII

100 grams of itaconic acid and 50 grams of deionized water were added to a 250 ml beaker and 30.8 grams of sodium hydroxide was added slowly while the beaker was kept cold with an ice water bath. The solution was then added to a 250 milliliter, 3-neck round bottom flask equipped with mechanical stirrer, nitrogen feed line, water cooled condenser, and thermometer 0.5 milliliter of 70% tertiobutyl hydroperoxide was added at once after the reaction mixture reached 100 degree centigrade. The reaction was held at 100 C for 160 minutes and then cooled down. The resultant material showed 72.5 percent conversion of the itaconic acid into a polymer as analyzed by ¹H-NMR. Based on gel permeation chromatography, the weight average molecular (Mw) was 20,150 g/mole, and the number average molecular weight (Mn) was 7,930 g/mole in polyacrylic acid equivalent molecular weight.

### Example IX

100 grams of itaconic acid and 50 grams of deionized water were added to a 250 ml, 3-neck round bottom flask equipped with mechanical stirrer, nitrogen feed line, water cooled condenser, and thermometer 0.5 milliliter of 70% tertiobutyl hydroperoxide was added at once after the reaction mixture reached 100 degree centigrade. The reaction was held at 100 C for 150 minutes and then cooled down. The resultant solution showed 26.8 percent conversion of the itaconic acid into a polymer polymer as analyzed by ¹H-NMR.

### Example X

The procedure of EXAMPLE VIII was repeated except 18.6 grams of sodium hydroxide was added slowly with manually stirring while the beaker was kept cold with an ice water bath. The reaction was held at 100 C for 150 minutes and then cooled down. The resultant solution showed 48.5 percent conversion of the itaconic acid into a polymer as analyzed by ¹H-NMR.

### Example XI

The procedure of EXAMPLE VIII was repeated except 43.1 grams of sodium hydroxide was added slowly with manually stirring while the beaker was kept cold with an ice water bath.

The reaction was held at 100 C for 150 minutes and then cooled down. The resultant solution showed 64.9 percent conversion of the itaconic acid into a polymer as analyzed by ¹H-NMR.

### Example XII

The procedure of EXAMPLE VIII was repeated except 61.6 grams of sodium hydroxide was added slowly with manually stirring while the beaker was kept cold with an ice water bath. The reaction was held at 100 C for 150 minutes and then cooled down. The resultant solution showed 26.2 percent conversion of the itaconic acid into a polymer as analyzed by ¹H-NMR.

### Example XIII

5000 gr of itaconic acid and 500 grams of deionized water were placed in a 10 L kneader-reactor at 50 C. 3077 grams of sodium hydroxide at 50 wt % in water was added over 15 minutes. 71 grams of 70% tertiobutyl hydroperoxide was added at once. The reactor was pressurized to 0.5 bar above atmospheric pressure with nitrogen then heated to 90° C. Mixing and heating were maintained for 130 minutes, and then the reactor was cooled down. The resultant material showed 95 percent conversion of the itaconic acid into a polymer as analyzed by ¹H-NMR. Based on gel permeation chromatography, the weight average molecular (Mw) was 29,136 g/mole, and the number average molecular weight (Mn) was 8.003 g/mole in polyacrylic acid equivalent molecular weight.

### Example XIV

4000 gr of itaconic acid was placed in a 10 L kneader-reactor at 70 C. 2462 grams of sodium hydroxide at 50 wt % in water was added over 15 minutes. 60 grams of tetraethylene glycol diacrylate was added. The reactor was pressurized to 0.5 bar above atmospheric pressure with nitrogen then heated to 100° C. 57 grams of 70% tertiobutyl hydroperoxide was added at once under pressure. Mixing and heating were maintained for 100 minutes, and then the reactor was cooled down. The resultant material showed 97 percent conversion of the itaconic acid into a polymer as analyzed by ¹H-NMR. Based on gel permeation chromatography, the weight average molecular (Mw) was 78,532 g/mole, and the number average molecular weight (Mn) was 6,866 g/mole in polyacrylic acid equivalent molecular weight.

### Example XV

4000 gr of itaconic acid was placed in a 10 L kneader-reactor at 70 C. 2462 grams of sodium hydroxide at 50 wt % in water was added over 12 minutes. 170 grams of 70% tertiobutyl hydroperoxide was added at once. The reactor was pressurized to 0.5 bar above atmospheric pressure with nitrogen then heated to 100° C. Mixing and heating were maintained for 65 minutes, and then the reactor was cooled down. The resultant material showed 99 percent conversion of the itaconic acid into a polymer as analyzed by ¹H-NMR. ¹³C-NMR analysis of the triads in the 177-178 ppm region resulted in a 64% syndiotacticity at pH=0.82. Based on gel permeation chromatography, the weight average molecular (Mw) was 18,586 g/mole, and the number average molecular weight (Mn) was 4,364 g/mole in polyacrylic acid equivalent molecular weight.

### Example XVI

5000 gr of itaconic acid was placed in a 10 L kneader-reactor at 70 C. 3077 grams of sodium hydroxide at 50 wt % in water was added over 15 minutes. 100 grams of tetraethylene glycol diacrylate and 71 grams of 70% tertiobutyl hydroperoxide were added at once. The reactor was pressurized to 0.5 bar above atmospheric pressure with nitrogen then heated to 90° C. Mixing and heating were maintained for 80 minutes, and then the reactor was cooled down. The resultant material showed 95 percent conversion of the itaconic acid into a polymer as analyzed by ¹H-NMR. The resulting polymer was crosslinked, and swelled 120 times its own mass of deionized water.

### Example XVII

650 gr of itaconic acid and 400 grams of sodium hydroxide at 50 wt % solution in water were co-added over 15 minutes into a 1 L jacketed reactor at 70° C. under mechanical stirring under nitrogen atmosphere. The reactor was then heated to 100° C. and 80 ml of 70 wt. % tertiobutyl hydroperoxide in water was added at once. Mixing and heating were maintained for 120 minutes, and then the reactor was cooled down. The resultant material showed 98.7 percent conversion of the itaconic acid into a polymer as analyzed by ¹H-NMR. ¹³C-NMR analysis of the triads in the 177-178 ppm region resulted in a 62% syndiotacticity. Based on gel permeation chromatography, the weight average molecular (Mw) was 12,800 g/mole, and the number average molecular weight (Mn) was 4,574 g/mole in polyacrylic acid equivalent molecular weight.

### Example XVIII

650 gr of itaconic acid and 400 grams of sodium hydroxide at 50 wt % solution in water were co-added over 15 minutes into a 1 L jacketed reactor at 70 C under mechanical stifling under nitrogen atmosphere. The reactor was then heated to 110° C. and 20 ml of 70 wt. % tertiobutyl hydroperoxide in water was added at once. Mixing and heating were maintained for 120 minutes, and then the reactor was cooled down. FIG. 7 shows the ¹H NMR spectra of the poly(itaconic acid, sodium salt) in D₂O. FIG. 8 shows the ¹³C NMR spectra of the poly(itaconic) in D₂O. The resultant material showed 99.7 percent conversion of the itaconic acid into a polymer as analyzed by ¹H-NMR. ¹³C-NMR analysis of the triads in the 177-178 ppm region resulted in a 61% syndiotacticity. Tacticity was measured by integrating by integrating the peak area triads in the 177-178 ppm range, seen in the enlargement in FIG. 8. Based on gel permeation chromatography, the weight average molecular (Mw) was 27,687 g/mole, and the number average molecular weight (Mn) was 7,867 g/mole in polyacrylic acid equivalent molecular weight.

### Example XIX

650 gr of itaconic acid and 400 grams of sodium hydroxide at 50 wt % solution in water were co-added over 15 minutes into a 1 L jacketed reactor at 70 C under mechanical stifling under nitrogen atmosphere. The reactor was then heated to 90° C. and 60 ml of 50 wt % hydrogen peroxide in water was added at once. Mixing and heating were maintained for 60 minutes, and then the reactor was cooled down. The resultant material showed 94 percent conversion of the itaconic acid into a polymer as analyzed by ¹H-NMR. Based on gel permeation chromatography, the weight average molecular (Mw) was 10,975 g/mole, and the number average molecular weight (Mn) was 3,795 g/mole in polyacrylic acid equivalent molecular weight.

### Example XX

650 gr of itaconic acid and 400 grams of sodium hydroxide at 50 wt % solution in water were co-added over 15 minutes into a 1 L jacketed reactor at 70 C under mechanical stifling under nitrogen atmosphere. The reactor was then heated to 100° C. and 40 ml of 50 wt % hydrogen peroxide in water was added at once. Mixing and heating were maintained for 120 minutes, and then the reactor was cooled down. The resultant material showed 95 percent conversion of the itaconic acid into a polymer as analyzed by ¹H-NMR. Based on gel permeation chromatography, the weight average molecular (Mw) was 17,520 g/mole, and the number average molecular weight (Mn) was 6,540 g/mole in polyacrylic acid equivalent molecular weight.

### Example XXI

In a 1.3 L continuously stirred tank reactor set at 80° C. with mechanical stifling under nitrogen atmosphere itaconic acid was uniformly fed at the rate of 2600 grams per hour. In the same reactor a sodium hydroxide aqueous solution at 50 wt % was co-fed uniformly at 1600 grams per hour. The content of this first reactor was continuously pumped out at the rate of 4200 grams per hour while maintaining the level of the reactor constant at 1 L. A solution of 50 wt % hydrogen peroxide in water was co fed uniformly into a mixing zone with the previous stream at the rate of 60 ml/hour. The resulting solution was pumped through a 775 ml tubular reactor (6.0 meters long by 1.24 cm diameter) coiled into a heated bath at 90° C. The resulting product streaming out of the tubular reactor continuously was cooled down to room temperature. Upon reaching steady state conditions, a representative sample of the material showed 52 percent conversion of the itaconic acid into a polymer (estimated by GPC). Based on gel permeation chromatography, the weight average molecular (Mw) was 168,440 g/mole, and the number average molecular weight (Mn) was 17,653 g/mole in polyacrylic acid equivalent molecular weight.

### Example XXII

67.7 gr of itaconic acid, 23.0 grams of sodium hydroxide at 50 wt % solution in water and 9.3 grams of pure sodium hydroxide were co-added over 15 minutes into a 250 ml round bottom flask at 80 C with magnetic stirring under nitrogen atmosphere. The reactor was then heated to 100° C. and 3.1 ml of 70 wt. % tertiobutyl hydroperoxide in water was added at once. Mixing and heating were maintained for 60 minutes, and then the reactor was cooled down. The resultant material showed 98.1 percent conversion of the itaconic acid into a polymer as analyzed by ¹H-NMR. ¹³C-NMR analysis of the triads in the 177-178 ppm region resulted in a 62% syndiotacticity at pH=0.20. Based on gel permeation chromatography, the weight average molecular (Mw) was 9,159 g/mole, and the number average molecular weight (Mn) was 3,573 g/mole in polyacrylic acid equivalent molecular weight.

### Example XXIII

In a 1.3 L continuously stirred tank reactor set at 80° C. with mechanical stifling under nitrogen atmosphere itaconic acid was uniformly fed at the rate of 1450 grams per hour. In the same reactor a sodium hydroxide aqueous solution at 50 wt % was co-fed uniformly at 890 grams per hour. The content of this first reactor was continuously pumped out at the rate of 2340 grams per hour while maintaining the level of the reactor constant at 1 L. A solution of 50 wt % hydrogen peroxide in water was co fed uniformly into a mixing zone with the previous stream at the rate of 120 ml/hour. The resulting solution was pumped through a 774 ml tubular reactor (2.0 meters long by 2.22 cm diameter) coiled into a heated bath at 90° C. The resulting product streaming out of the tubular reactor continuously was cooled down to room temperature. Upon reaching steady state conditions, a representative sample of the material showed 92 percent conversion of the itaconic acid into a polymer (estimated by GPC). Based on gel permeation chromatography, the weight average molecular (Mw) was 318,000 g/mole, and the number average molecular weight (Mn) was 28,900 g/mole in polyacrylic acid equivalent molecular weight.

Commercial Poly(itaconic acid)

A poly(itaconic acid) was made available from ‘Monomer-Polymer and Dajac Labs, Inc. and analyzed. The commercial polymer showed 48% percent of purity in polymer as analyzed by ¹H-NMR. Purification/concentration was required in order to perform the ¹³C-NMR analysis. and was done with a 3000MWCO filter by centrifugation. ¹³C-NMR analysis of the triads in the 177-178 ppm region resulted in a 52% syndiotacticity (pH=0.94). Based on gel permeation chromatography, the weight average molecular (Mw) was 19600 g/mole, and the number average molecular weight (Mn) was 3700 g/mole in polyacrylic acid equivalent molecular weight.

### Comparative Polymerization I

To a one neck glass round bottom flask equipped with a reflux condenser and a magnetic stirrer, was added 50 ml 0.5M HCl, 10 g of itaconic acid and 0.60 g of potassium persulfate. The content was heated at 60° C. during 68 hours. The polymer solution was precipitated in acetone (HPLC grade). Filtration was performed and the solid obtained was dried in the oven at 50° C. ¹³C-NMR analysis of the triads in the 177-178 ppm region resulted in a 46.5% syndiotacticity (pH=1.05). Based on gel permeation chromatography, the weight average molecular weight (Mw) was 17,800 g/mole, and the number average molecular weight (Mn) was 8,800 g/mole in polyacrylic acid equivalent molecular weight. It is noted that this comparative polymerization I is based upon method A reported in: “Polymerization of Itaconic Acid In Aqueous Solution: Structure Of The Polymer And Polymerization Kinetics At 25° C. Studied By Carbon-13 NMR”, Grespos et al, Makromolekulare Chemie, Rapid Communications (1984), 5(9), 489-494.

### Comparative Polymerization II

To a three neck glass round bottom flask equipped with a reflux condenser, a magnetic stirrer, under nitrogen atmosphere, was added 83 ml of m-xylene, 7.5 g of itaconic anhydride and 0.17 g of AIBN. The reaction mixture was heated at 60° C. for 2 days. The resulting poly(itaconic anhydride) was filtered, washed with m-xylene and ethyl ether. The solid (4.6 g) was then mixed with 15 ml of water overnight. The solution was dried under vacuum (10 mmHg) at 50° C. The resultant material showed 83 percent pure in polymer as analyzed by ¹H-NMR. ¹³C-NMR analysis of the triads in the 177-178 ppm region resulted in a 34% syndiotacticity (pH=0.88). Based on gel permeation chromatography, the weight average molecular weight (Mw) was 7,505 g/mole, and the number average molecular weight (Mn) was 2,915 g/mole in polyacrylic acid equivalent molecular weight. It is noted that this comparative polymerization II is based upon method C reported in: “Polymerization of Itaconic Acid In Aqueous Solution: Structure Of The Polymer And Polymerization Kinetics At 25° C. Studied By Carbon-13 NMR”, Grespos et al, Makromolekulare Chemie, Rapid Communications (1984), 5(9), 489-494.

### Comparative Polymerization III

To a three neck glass round bottom flask equipped with a reflux condenser, a magnetic stirrer, under nitrogen atmosphere, was added 11.6 ml of deionnized water. The flask was heated at 90° C. A monomer solution of 20.45 g of itaconic acid, 12.35 g of 50 percent NaOH and 7 g of DI water was prepared. An initiator solution of 1.75 g of potassium persulfate and 25.8 g of water was also prepared. The monomer and initiator solutions were fed into the flask linearly and separately over 2 hours, while maintaining the flask at a temperature sufficient to continue to reflux the mixture, about 100° C. When the addition was complete, the polymer solution was held at temperature for an additional 30 min. The resultant polymer solution had a conversion of 35% (estimated by GPC). The solution was precipitated in acetone. The solid was dried at 50° C. Further purification had to be done to provide quality NMR data. 1 g of product was dissolved in 2 g of D₂O and introduced in a 3000 MW filter centrifuge tube. After centrifugation at 8000 rpm for 10 minutes, the retentate was washed twice with 1 ml of D₂O and the pH was adjusted to 0.53. ¹³C-NMR analysis of the triads in the 177-178 ppm region resulted in a 49% syndiotacticity. Based on gel permeation chromatography, the weight average molecular weight (Mw) was 1,400 g/mole, and the number average molecular weight (Mn) was 1,000 g/mole in polyacrylic acid equivalent molecular weight. It is noted that this comparative polymerization III is based upon Example I in U.S. Pat. No. 5,336,744.

### Comparative Polymerization IV

To a three neck glass round bottom flask equipped with a reflux condenser, a magnetic stirring, under nitrogen atmosphere, was added 23.95 ml of deionnized water, 20.45 g of itaconic acid and 12.35 g of 50 wt % percent NaOH. An initiator solution of 1.54 g of sodium persulfate and 5.79 ml of deionized water was also prepared. The initiator solution was fed into the flask over 2 hours, while maintaining the flask at a temperature sufficient to continue to reflux the mixture, about 100° C. When the addition was complete, the polymer solution was held at temperature during 30 min. The resultant polymer solution had a conversion of 36% (estimated by GPC). The resultant polymer solution was precipitated in acetone. The solid was dried at 50 C. The resulting material was further purified. 1 g of product was dissolve in 2 g of D₂O and introduce in a 3000 MW filter centrifuge tube. After centrifugation at 8000 rpm for 10 minutes, the retentate was washed twice with 1 ml of D₂O and the pH was adjusted to 0.75. ¹³C-NMR analysis of the triads in the 177-178 ppm region resulted in a 53% syndiotacticity. It is noted that this comparative polymerization IV is based upon Example II in U.S. Pat. No. 5,336,744.

### Retanning with Polycarboxlyic Polymers-Poly(Itaconic Acid)

It has now been found that the polycarboxylic acid polymers herein having ¹³C NMR triads having a syndiotacticity of greater than 58.0% and/or Mw values of at or above 20,000 g/mole, offer significant improvements to the retanning of leather sourced from animal skins and/or synthetic leather. Animal skin leather may therefore be understood herein as hides, such as those from bovines, skins such as those from pig, sheep, deer and snake, and pelts from furry animals, such as rabbits, mink, sable and otter, that have been subject to chrome or other metal or vegetable tanning steps.

Synthetic leather may be understood to include man-made materials using tissue engineering and biotechnology to produce bio-materials with composition and properties similar to natural animal made leather. Such process can include the production of proteins and other bio-materials by engineered organisms in industrial size fermentation equipment, followed by directed or self assembly of these materials in a structural material that resemble leather due to the presence of fibrous protein such as collagen. Such man-made materials can benefit from the tanning and retanning process described in the application herein and the use of the polycarboxylic acid polymers in retanning.

In addition, it has also been found that the polycarboxylic acid polymers noted herein as applied to the leather in retanning also can provide for protection of the iron to iron staining. Extracts (Chestnut, Quebracho, Tara, Wattle; others) are widely used in retanning. Extracts are sensitive to reactions with metal ions which cause blue or purple stains (known as iron stains) on leather. Chelating agents, such as ethylenediaminetetraacetic acid (EDTA) are often used to tie up metal ions and protect the leather from these stains. By using the polycarboxylic acid polymers noted herein, one can now reduce or eliminate the need of using subsequent chelating agents.

The polycarboxylic acid polymers herein are particularly useful as applied to chrome tanned leather, which may sometimes be referred to as wet blue stock or wet blue. Retanned leather herein may be understood as tanned leather that has been subjected to a retanning step, wherein the retanning step is applied to optimize one or more characteristics of the tanned leather material. Such characteristics include, but are not limited to, color, firmness, strength, levelness, softness, fullness, and behavior to water (hydrophobicity) and to fix tanning agents.

The retan process utilized herein is conducted in an aqueous environment in a suitable drum container. The chromed leather is first placed into the drum for the retan, which begins with neutralization. After neutralization the leather proceeds through the retan procedure. During retan, various extracts, syntans and/or polymeric resins may be employed. Dyes and other extracts may be added to enhance certain characteristics of the finished leather that are desired. Accordingly, the retan process may optionally be configured to provide a particular type of leather having particular finished characteristics. Acidification is conducted to ensure the fixation of the reagents employed in the retan. This is then followed by fat-liquoring (waterproofing). Acidification is also applied for fixation of the reagents employed in fat-liquoring.

Three (3) retan procedures were employed to compare and evaluate the role of the polymers herein in the treatment of tanned leather. The retan procedures are summarized in the tables below:

TABLE I
Comparative Retanning of Leather
1.99 mm [Based on Blue Shaved Weight]

| | | | | | |
|---|---|---|---|---|---|
| | | Water | Temp | Time | |
| Add % | Description | (%) | (° C.) | (min) | pH |

| | | | | |
|---|---|---|---|---|
| | Float | 150 | 40 | |
| 0.35 | Formic Acid | 10 | 30 | 15 |
| 2.00 | Chrome SR-35 | Dry | | 60 |
| | (Chrome)(Re- | | | |
| | chrome) | | | |
| 2.50 | Sodium Formate | 20 | 40 | 60 |
| | (Neutralization) | | | |
| | Drain, Refloat, | 300 | 40 | 10 |
| | Wash | | | |
| | Drain, Refloat | 50 | 40 | |
| 1.0 | Chemtan E-33 | | | |
| | Phenolic Syntan | | | |
| | (Retan) | | | |
| 6.0 | Variations | 25 | 40 | 30 |
| 4.0 | Chestnut KPN | | | |
| | (Extract)(Retan) | | | |
| 3.0 | Chemtan Filler FB | | | |
| | (Protein Filler) | | | |
| | (Retan) | | | |
| | Dye | Dry | | 60 |
| 1.0 | Formic Acid | 10 | 30 | 15 |
| | Drain, Refloat, | 300 | 50 | 10 |
| | Wash | | | |
| | Drain, Refloat | 150 | 50 | |
| 1.0 | Sodium Formate | Dry | | 10 |
| 3.0 | Chemtan S-52 | 15 | 60 | 30 |
| | (Hydrophobic | | | |
| | Polymer)(Farliquor) | | | |
| 3.0 | Chemtan S-52 | 15 | 60 | 60 |
| | (Hydrophobic | | | |
| | Polymer) (Faliquor) | | | |
| 2.0 | Formic Acid (2 | 10 | 30 | 10/20 |
| | feeds) | | | |
| | Drain, Refloat, | 300 | 40 | 10 |
| | Wash | | | |
| | Drain, Refloat | 50 | 40 | |
| | DYE II | | | |
| 0.75 | Formic Acid | 10 | 30 | 15 |
| | Drain, Refloat | 75 | 50 | |
| 2.0 | Chemtan S-52 | 25 | 50 | 20 |
| | (Hydrophobic | | | |
| | Polymer)(Silicon) | | | |
| 2.0 | Formic Acid (2 | 10 | 30 | 10/20 |
| | feeds) | | | |
| 1.0 | Chrome SR-35 | Dry | | |
| | (Chrome)(metal | | | |
| | cap) | | | |
| 2.0 | Chemtan M-25 (2 | 15 | 40 | 30/30 |
| | feeds)(Zironium | | | |
| | Sulfate)(metal cap) | | | |
| | Final Wash | 300 | 30 | 15 |

*Variations: 1. 990 g of leather/no acrylic; 2. 975 g Chemtan R-74LC; 3. 1000 g poly sodium itaconate with Mn = 1750 g/mole; 4. 985 g poly sodium itaconate with Mn = 2800 g/mole; 5. 1000 g poly sodium itaconate with Mn = 5800 g/mole.

The above Table may be understood as follows: the indicated thickness of the leather is based on blue shaved weight (chromed leather). Reading the Table left to right, the following is noted: Column 1 is the percent chemical added based on the weight of the blue stock. Column 2 is the name and description of the chemical added. Column 3 is the percent water added based on the weight of the blue stock. The chemical is diluted by the percent water listed in the same row. Dry refers to the chemical being added neat and not diluted. A space in this location denotes that the chemical is added at the same time as subsequent chemicals. Column 4 specifies the temperature of the water being used. Column 5 specifies how long the drum runs before the next chemical is added. Column 6 is the pH that may be recorded. Reference to blue shaved weight should be understood herein as reference to the thickness of the chrome blue stock.

The variations are added at a level of 6% based on the weight of the blue stock, and as noted, there were five (5) variations evaluated according to the procedure identified in Table 1 to allow for a comparison of the poly(itaconic acid) to other polymers for the retanning of leather.

Below in Table 2 is another comparative retan procedure which may be read in accordance with the description noted above for Table 1:

TABLE 2
Comparative Retan of Leather
1.99 mm (Based on Shaved Weight)

| Add % | Description | Water (%) | Temp. (° C.) | Time (min) | pH |
|---|---|---|---|---|---|
| | Float, Wash | 200 | 30 | 15 | |
| | Drain, Reflot | 100 | 30 | | |
| 1% | Sodium | | | | |
| | Bicarbonate | | | | |
| | (neutralization) | | | | |
| 4% | Chemtan N-36 | 10 | 30 | 60 | 7.47 |
| | (neutralizing | | | | |
| | salt) | | | | |
| | Drain, Refloat, | 200 | 30 | 10 | |
| | Wash | | | | |
| | Drain, Refloat | 100 | 30 | | |
| 6.0 | Varation (see | 10 | 30 | 20 | |
| | below) | | | | |
| 5.0 | Chemtan E-33 | 10 | 30 | 30 | |
| | (phenolic | | | | |
| | syntan) | | | | |
| 1.0 | Chemtan | 10 | 60 | 30 | |
| | Brown MF | | | | |
| | (dye) | | | | |
| 1.0 | Formic Acid | 10 | 30 | 15 | 4.16 |
| | Drain, Refloat, | 200 | 30 | 10 | |
| | Wash | | | | |
| | Drain, Refloat | 100 | 50 | | |
| 8.0 | Chemol 524 | 10 | 50 | 45 | |
| | (non bleaching | | | | |
| | oil) fatliquor | | | | |
| 1.0 | Formic acid | 10 | 30 | 15 | 3.41 |
| | Drain, Refloat, | 300 | 30 | 10 | |
| | Wash | | | | |
| | VARIATIONS | | | | |
| 1. | Negative | | | | |
| | Control | | | | |
| 2 | Chemtan | | | | |
| | R74LC | | | | |
| 3. | poly sodium | | | | |
| | itaconate with | | | | |
| | Mn = 2800 | | | | |
| | g/mole solid | | | | |
| | dissolved in | | | | |
| | water at 30 | | | | |
| | wt % | | | | |

Below in Table 3 is another comparative retan procedure which may be read in accordance with the description noted above for Table 1.

TABLE 3
Comparative Retan of Leather
2.5 mm Based on Blue Shaved Weight

| | | | | Time |
|---|---|---|---|---|
| Add % | Description | Water (%) | Temp. (° C.) | (min) |
| | Float | 150 | | |
| 2.00 | Sodium | Dry | | 10 |
| | Formate | | | |
| | (neutralization) | | | |
| 0.75 | Sodium | | | |
| | Bicarbonate | | | |
| | (neutralization) | | | |
| 3.00 | Chemtan T-25 | 15 | 40 | 10 |
| | (neutralizing | | | |
| | syntan) | | | |
| | (neutralization) | | | |
| | Drain, Refloat, | 300 | 40 | 10 |
| | Wash | | | |
| | Variation | | | |
| 1.5 | Chemtan | | | |
| | Brown CB | | | |
| | (dye) | | | |
| 0.75 | Chemtan Olive | | | 60 |
| | Brown G (dye) | | | |
| 1.00 | Formic Acid | 10 | 30 | 10 |
| 1.00 | Formic Acid | 10 | 30 | 20 |
| | Drain, Refloat, | 300 | 50 | 10 |
| | Wash | | | |
| | Drain, Refloat | 100 | 50 | |
| 8.00 | Chemol 378 | 20 | 50 | 45 |
| | (non-bleaching | | | |
| | oil) (fatliquor) | | | |
| 1.00 | Formic Acid | 10 | 30 | 15 |
| | Drain, Refloat, | 300 | 40 | 10, 10 |
| | Wash x2 | | | |
| | Variations | | | |
| 1 | Negative | | | |
| | Control | | | |
| 9 | 8% Chemtan | | | |
| | R-74LC | | | |
| 11 | 5% poly | | | |
| | sodium | | | |
| | itaconate with | | | |
| | Mn = 2800 | | | |
| | g/mole | | | |

Strengthening of Tanned Leather

Retan procedure of Table 1 above was employed for evaluation of leather strenghtening. The data below is for the variation utilizing poly sodium itaconate with Mn=2800 g/mole. In Table 4 below, reference to negative control is that situation where no polycarboxylate is applied. Chemtan R-74LC is an acrylic acid based polymer.

TABLE 4
Mechanical Properties Of Retanned Leather

| | Tensile | Elongation | Tensile | Elongation | | |
|---|---|---|---|---|---|---|
| | (Parallel) | (Parallel) | (Perpendicular) | (Perpendicular) | Mullen | Stitch |
| Comment | (PSI) | (mm) | (PSI) | (mm) | (PSI) | (N) |
| Negative | 37.8 | 54.8 | 26.2 | 43.9 | 70.8 | 74.5 |
| Control | | | | | | |
| Chemtan | 38.5 | 60.1 | 26.8 | 44.5 | 75.2 | 80.1 |
| R-74LC | | | | | | |
| Itaconix | 39.9 | 63.5 | 32.3 | 47.2 | 77.5 | 93.2 |
| 2K | | | | | | |

As can be seen from the above, there was a 5% increase in parallel and 20% increase in perpendicular tensile strength. A 5% increase in parallel and perpendicular tensile elongation was also observed. There was also a 9% increase in Mullen burst strength and a 20% increase in Stitch tear. The tests were conducted according to ASTM D2209 (tensile), D2211 for elongation, D4705 for stitch tear and D2210 for Mullen grain burst.

Firmness of Leather & Water Resistance

Retan procedure 1 above was employed. The data below in Table 5 is for the variation utilizing poly sodium itaconate with Mn=2800 g/mole. In the table below, reference to negative control is that situation where no polycarboxylate is applied. Chemtan R-74LC is an acrylic acid based polymer.

TABLE 5
Firmness & Water Resistance Of Retanned Leather

| | Firmness | | Static Water | Dynamic Water |
|---|---|---|---|---|
| Comment | (Parallel) | Maesers | Absorption | Absorption |
| Negative | Dry: 160 | >130,000 | 14.5% | 2.74% |
| Control | Wet: 200 | | | |
| Chemtan R- | Dry: 200 | >130,000 | 12.93% | 2.39% |
| 74LC | Wet: 265 | | | |
| poly sodium | Dry: 250 | >130,000 | 13.3% | 2.93% |
| itaconate with | Wet: 320 | | | |
| Mn = 2800 | | | | |
| g/mole | | | | |

There was a 60% increase in the firmness of the leather utilizing poly sodium itaconate with Mn=2800 g/mole as compared to the negative control. There was a 25% increase in firmness as compared to Chemtan R-74LC. Firmness was measured according to ASTM D2821. ASTM D2209 and D6015 were employed for dynamic and static water absorption. The leather treated with poly sodium itaconate with Mn=2800 g/mole maintained a water resistant leather suitable for a variety of finished leather goods.

Color Value & Levelness

The polyitaconic acid polymers herein demonstrated improved color levelness compared to control leather that is untreated. Poly(itaconic acid) was applied to leather during retanning pursuant to Table 2 above. The product was tested and demonstrated improved color value compared to acrylic acid based polymeric acids. There was a 30% increase in value from a 2 to a 3-4 change using that AATCC Grey Scale. AATCC is reference to the American Association of Textile Chemist and Colorist.

In addition, reflectance measurements were conducted for color value. A reflectometer was employed wherein L=0 means black, L=100 means white. The results indicated that the 5% poly sodium itaconate with Mn=2800 g/mole (Table 3) had an L value of 38.95. The results also indicated that the 8% Chemtan R-74LC (Table 3) had an L value of 44.12.

It should also be appreciated that all of the various embodiments noted herein are interchangeable and features within any of the drawings may be used within each of the respective drawings, to optimize any and all of the disclosed characteristics of the polymerizations noted herein and the utility of the polymers for retanning of leather.

The foregoing description of several methods and embodiments has been presented for purposes of illustration. It is not intended to be exhaustive and obviously many modifications and variations are possible in light of the above teaching.

What is claimed is:

1. A process for retanning of leather sourced from animal skins or synthetic leather comprising:
treatment of said leather with a polymer material comprising the following repeating units: [chemical structure]
wherein R₁ and R₂ are selected from a hydrogen atom or an alkyl group or an aromatic group, or a cyclic alkyl group or a polyether, and combinations thereof and R₃ may be selected from an alkyl group, aromatic functionality, heteroaromatic functionality, cyclic alkyl group, heterocylic group, or combinations thereof, wherein at least 50 mole % of R₁ and R₂ are a hydrogen atom to provide carboxylic acid functionality and the polymer material has at least one of: (1) ¹³C NMR triads having a syndiotacticity of greater than 58.0%; or (2) the value of n for the indicated repeating unit provides a weight average molecular weight of at or above 20,000.

2. The process of claim 1 wherein R₁ and R₂ are selected from a hydrogen atom and R₃ comprises a methylene linkage.

3. The process of claim 1 wherein said polymer indicates ¹³C NMR triad having a syndiotacticity of 58% to 75%.

4. The process of claim 1 wherein the value of n for the indicated repeating unit provides a polymer with a weight average molecular weight of 20,000 to 100,000 g/mole.

5. A process for retanning of leather sourced from animal skins or synthetic leather comprising:
treatment of said leather with a polymer material comprising the following repeating units: [chemical structure]
wherein the polymer material has ¹³C NMR triads having a syndiotacticity of greater than 58.0%.

6. The process of claim 5 wherein said polymer indicates ¹³C NMR triad having a syndiotacticity of 58% to 75%.

7. The process of claim 5 wherein the value of n for the indicated repeating unit provides a polymer with a weight average molecular weight of greater than 20,000.

8. The process of claim 5 wherein the value of n for the indicated repeating unit provides a polymer with a weight average molecular weight of 20,000-100,000 g/mole.

9. The process of claim 5 wherein the polymer is partially or completely neutralized with an inorganic base.

10. The process of claim 9 wherein said inorganic base is M⁺[OH—]ₓ where M represents a cationic moiety selected from sodium, potassium, and/or lithium and x assumes a value to provide a neutralized salt.

11. The process of claim 9 wherein the polymer is partially or completely neutralized with a non-metallic hydroxide.

12. The process of claim 11 wherein said non-metallic hydroxide comprises ammonium hydroxide.

13. The process of claim 9 wherein said polymer is partially or completely neutralized with an organic base.

14. The process of claim 11 wherein said organic base comprises an organic amine.

15. A process for retanning of leather sourced from animal skins or synthetic leather comprising:
treatment of said leather with a polymer material comprising the following repeating units: [chemical structure]
wherein the value of n is such that the polymer has a weight average molecular weight of at or above 20,000 g/mole.

16. The process of claim 15 wherein the weight average molecular weight (Mw) is 20,000 to 1,000,000 g/mole.

17. The process of claim 15 wherein the number average molecular weight (Mn) is greater than or equal to 2,000 g/mole.

18. The process of claim 15 wherein the number average molecular weight (Mn) is 2,000 to 25,000 g/mole.

19. The process of claim 15 wherein the polymer is partially or completely neutralized with an inorganic base.

20. The process of claim 19 wherein said inorganic base is M⁺[OH—]ₓ where M represents a cationic moiety selected from sodium, potassium, and/or lithium and x assumes a value to provide a neutralized salt.

21. The process of claim 15 wherein the polymer is partially or completely neutralized with a non-metallic hydroxide.

22. The process of claim 21 wherein said non-metallic hydroxide comprises ammonium hydroxide.

23. The process of claim 15 wherein said polymer is partially or completely neutralized with an organic base.

24. The process of claim 23 wherein said organic base comprises an organic amine.
